(19) United States
(12) Patent Application Publication
(10) Pub. No.: US 2022/0049549 A1
(43) Pub. Date: Feb. 17, 2022

(54) CLUTCH, MOTOR DEVICE, CURTAIN CONTROL DEVICE AND CURTAIN

(71) Applicant: NINGBO SUNFREE MOTOR TECHNOLOGY COMPANY LIMITED, Ningbo (CN)

(72) Inventors: Chun JIANG, NINGBO (CN); Yongqiang ZHOU, NINGBO (CN)

(21) Appl. No.: 17/399,411

(22) Filed: Aug. 11, 2021

(30) Foreign Application Priority Data
Aug. 12, 2020 (CN) 202010805409.6

(51) Int. Cl. E06B 9/70; F16D 28/00

(52) U.S. Cl. CPC E06B 9/70; F16D 23/12; F16D 28/00

(57) ABSTRACT

The present invention has disclosed a clutch, a motor device, a curtain control device and a curtain. The clutch comprises a drive force outputting part, a transmission part, sleeved between the drive force outputting part, and a clutch piece mounting position is provided on the transmission part; a drive force receiving part with a driving force transmitting part, arranged on the side of the transmission part away from the driving force receiving part; a clutch control part, disposed on one side of the driving force receiving part, comprising a combination piece, disposed on the drive force receiving part; a separation accommodation zone, arranged between two combination surfaces; a clutch piece, arranged on the clutch piece mounting position. The embodiments of the present invention effectively solve the problems resulting from use of magnetic separation in realizing engaging and disengaging functions of an existing clutch.

### CROSS-REFERENCE TO RELATED APPLICATIONS

This application claims priority to Chinese Patent Application No. 202010805409.6 with a filing date of Aug. 12, 2020. The content of the aforementioned application, including any intervening amendments thereto, are incorporated herein by reference.

### TECHNICAL FIELD

The present invention relates to the field of clutch control technologies, and in particular to a clutch, a motor device, a curtain control device and a curtain.

### BACKGROUND

A clutch, as a basic component in mechanical transmission of mechatronics, usually implements engaging and disengaging functions by magnetic disengagement. The existing clutch mainly implements engaging and disengaging functions based on electromagnetic principle or magnetic component, especially a mechanical clutch mainly implements engaging and disengaging functions with magnetic beads. In this way, the clutch has a relatively simple structure, and magnetism is easier to control.

However, a clutch implementing engaging and disengaging functions with an electromagnetic device has a large volume difficult to shrink, and the clutch implementing engaging and disengaging functions with a magnetic component has a problem of demagnetization of the magnetic component.

### SUMMARY

Therefore, an embodiment of the present invention provides a clutch, a motor device, a curtain control device and a curtain to effectively solve the problems resulting from use of magnetic separation in realizing engaging and disengaging functions of an existing clutch.

According to an aspect of the embodiments of the present invention, provided is a clutch, comprising a drive force receiving part, and a drive force outputting part; a transmission part, sleeved between the drive force receiving part and the drive force outputting part, where the drive force receiving part is rotatable relative to the transmission part; and a clutch control part, sandwiched between the drive force receiving part and the drive force outputting part, comprising: a clutch piece, disposed in the transmission part and in contact with the drive force outputting part; a separation accommodation zone, located at a side of the drive force receiving part close to the transmission part; and a combination piece, disposed at a side of the drive force receiving part close to the transmission part and close to the separation accommodation zone. When the clutch piece is located in the separation accommodation zone, a gap is disposed between the clutch piece and the drive force receiving part; when the drive force receiving part rotates, the clutch piece is sandwiched between the combination piece and the drive force outputting part.

In an embodiment of the present invention, the combination piece comprises a first combination surface and a second combination surface; the separation accommodation zone is sandwiched between the first combination surface and the second combination surface. When the drive force receiving part rotates forward, the clutch piece is sandwiched between the first combination surface and the drive force outputting part; when the drive force receiving part rotates backward, the clutch piece is sandwiched between the second combination surface and the drive force outputting part.

In an embodiment of the present invention, at least two clutch pieces are disposed, and the at least two clutch pieces are disposed at different positions of the transmission part. A corresponding separation accommodation zone and a corresponding combination piece corresponding to each of the clutch pieces are disposed at the side of the drive force receiving part close to the transmission part respectively.

In an embodiment of the present invention, the clutch piece is a cylindrical body or a spherical body sleeved on the transmission part.

In an embodiment of the present invention, the transmission part is sleeved around the drive force outputting part, and the drive force receiving part is sleeved around the transmission part.

In an embodiment of the present invention, the transmission part is sleeved around the drive force receiving part, and the drive force outputting part is sleeved around the transmission part.

In an embodiment of the present invention, the clutch further comprises a drive force receiving rod connected with the drive force receiving part, and a drive force outputting rod connected with the drive force outputting part.

In an embodiment of the present invention, the clutch further comprises a damping piece disposed on the transmission part.

According to another aspect of an embodiment of the present invention, provided is a motor device, comprising: the clutch according to any one of the above embodiments; and a motor body, having a drive shaft connected with the drive force receiving part of the clutch.

According to still another aspect of an embodiment of the present invention, provided is a curtain control device, comprising: the motor device according to any one of the above embodiments; a first wire reel connected to the drive force outputting part of the motor device; a second wire reel; and a curtain control rope, wound between the first wire reel and the second wire reel.

According to yet another aspect of an embodiment of the present invention, provided is a curtain, comprising: a curtain body provided with the motor device according to any one of the above embodiments.

In conclusion, the above different embodiments of the present invention may have one or more advantages or beneficial effects as follows: i) the clutch piece may be switchably located in the separation accommodation zone and the combination piece to engage or disengage the clutch piece with or from the drive force receiving part, thus realizing the engaging and disengaging functions; the engaging and disengaging functions are realized in a pure mechanical manner without using a magnetic component, thereby avoiding a problem caused by the magnetic component; ii) the clutch piece may be moved back and forth in the separation accommodation zone along with the rotation of the drive force receiving part, such that the clutch piece can be switched between the first combination surface and the second combination surface, finally allowing the clutch to realize engaging and disengaging functions under a drive force of a first direction (e.g. clockwise) or a second direction (e.g. counterclockwise).

### BRIEF DESCRIPTIONS OF THE DRAWINGS

In order to describe the technical solutions of the embodiments of the present invention more clearly, brief descriptions will be made below to accompanying drawings involved in descriptions of the embodiments. Obviously, the accompanying drawings in the following descriptions are merely some embodiments of the present invention, and other drawings may also be obtained by those of ordinary skill in the art based on these drawings without paying creative work.

FIG. 1 is a structural schematic diagram of a clutch 100 according to a first embodiment of the present invention.

FIG. 2 is a sectional view taken along A-A of the clutch 100 shown in FIG. 1.

FIG. 3 is a partial enlarged view of the position B in FIG. 2.

FIG. 4 is an exploded view of the clutch 100 shown in FIG. 1.

FIG. 5 is a top view of the clutch 100 shown in FIG. 1.

FIG. 6 is a schematic diagram of a positional relationship of a clutch piece 31 and a transmission part 20 in a structure shown in FIG. 2.

FIG. 7 is a schematic diagram of a positional relationship of a clutch piece 31 and a transmission part 20 in another structure shown in FIG. 1.

FIG. 8 is a structural schematic diagram of a motor device 200 according to a second embodiment of the present invention.

FIG. 9 is another structural schematic diagram of a motor device 200 according to a second embodiment of the present invention.

FIG. 10 is a structural schematic diagram of a curtain control device 300 according to a third embodiment of the present invention.

The reference numerals of the drawings are described as follows:

100 clutch, 10 drive force receiving part, 11 drive force receiving rod, 20 transmission part, 21 clutch piece mounting position, 30 clutch control part, 31 clutch piece, 32 separation accommodation zone, 33 combination piece, 34 first combination surface, 35 second combination surface, 40 drive force outputting part, 41 drive shaft mounting position, 42 drive force outputting rod, 50 first region, 60 second region, 200 motor device, 210 motor body, 211 drive shaft, 220 speed reducer, 300 curtain control device, 310 first wire reel, 320 second wire reel, and 330 curtain control rope.

### EMBODIMENTS

The technical solutions in the embodiments of the present invention will be fully and clearly described below in combination with the accompanying drawings involved in the embodiments of the present invention. Obviously, the embodiments described herein are merely some embodiments of the present invention rather than all embodiments. Other embodiments obtained by those of ordinary skill in the art based on these embodiments without paying creative work will all fall within the scope of protection of the present invention.

### First Embodiment

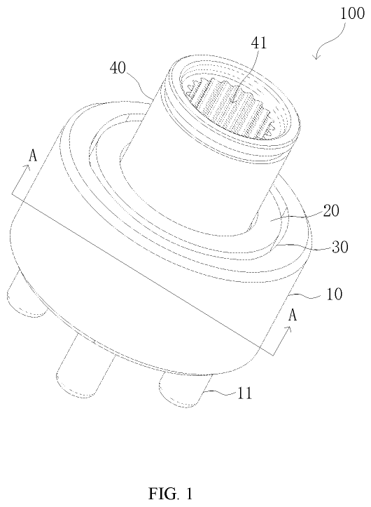

FIG. 1 is a structural schematic diagram of a clutch 100 according to a first embodiment of the present invention. The clutch 100 comprises, for example, a drive force receiving part 10, a drive force outputting part 40, a transmission part 20 sandwiched between the drive force receiving part 10 and the drive force outputting part 40, and a clutch control part 30 located between the drive force receiving part 10 and the transmission part 20. The drive force receiving part 10 may be engaged with the drive force outputting part 40 through the clutch control part 30 to drive the drive force outputting part 40 to rotate. The drive force receiving part 10 may also be disengaged from the drive force outputting part 40 through the clutch control part 30 to enable the drive force outputting part 40 to rotate relative to the transmission part 20.

The drive force receiving part 10 is connected with, for example, a drive force receiving rod 11 which may be connected at a side of the drive force receiving part 10 away from the transmission part 20; the drive force outputting part 40 is provided with, for example, a drive shaft mounting position 41 which may be connected at a side of the drive force outputting part 40 away from the transmission part 20. The drive shaft mounting position 41 outputs a drive force and connects with other rotary shaft or turntable.

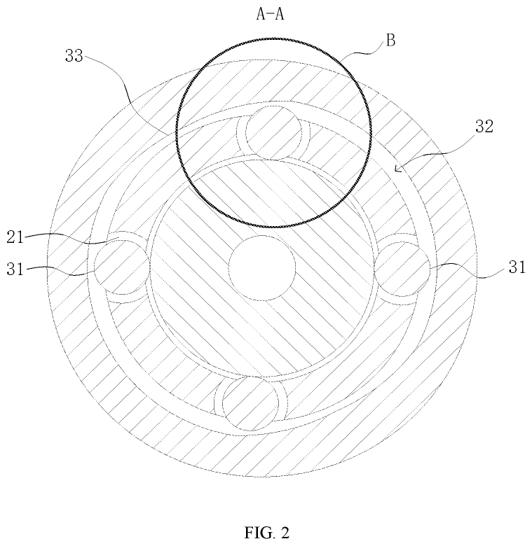

Specifically, with reference to FIG. 2, the clutch control part 30 comprises, for example, a separation accommodation zone 32 and a combination piece 33. The separation accommodation zone 32 and the combination piece 33 are disposed at a side of the drive force receiving part 10 close to the transmission part 20 respectively. For example, a distance from the separation accommodation zone 32 to a central axis of the drive force receiving part 10 is greater than a distance from the combination piece 33 to the central axis. The separation accommodation zone 32 may be one segment of inner wall of a side of the drive force receiving part 10 close to the clutch control part 30, and the segment of inner wall may be of arc-shaped structure. Similarly, the combination piece 33 may be another segment of inner wall of the side of the drive force receiving part 10 close to the clutch control part 30, and the segment of inner wall may also be of arc-shaped structure. The above two segments of inner wall may be adjacent to each other. Furthermore, the combination piece 33 at least comprises a first combination surface 34 and a second combination surface 35, and the separation accommodation zone 32 is sandwiched between the first combination surface 34 and the second combination surface 35.

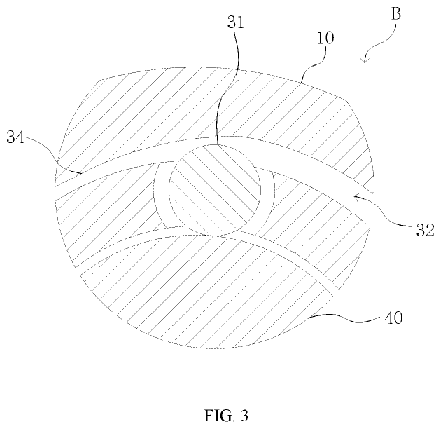

Furthermore, a gap (not shown) is disposed between the drive force receiving part 10 and the clutch control part 30, a larger part of the gap between the drive force receiving part 10 and the clutch control part 30 is a first gap which is referred to as the separation accommodation zone 32, a smaller part of the gap between the drive force receiving part 10 and the clutch control part 30 is a second gap, and an inner wall of the drive force receiving part 10 corresponding to the second gap is the combination piece 33. Preferably, the clutch control part 30 further comprises, for example, a clutch piece 31 which is sandwiched between the drive force receiving part 10 and the drive force outputting part 40. The clutch piece 31 may rotate relative to the drive force receiving part 10 and the drive force outputting part 40. The clutch piece 31 is in contact with the drive force outputting part 40. With reference to FIG. 3, when the clutch piece 31 is located in the separation accommodation zone 32, the clutch piece 31 is not in contact with the drive force receiving part 10; and when the clutch piece 31 leaves the separation accommodation zone 32, the clutch piece 31 is in contact with the combination piece 33, that is, the clutch piece 31 is sandwiched between the combination piece 33 and the drive force outputting part 40.

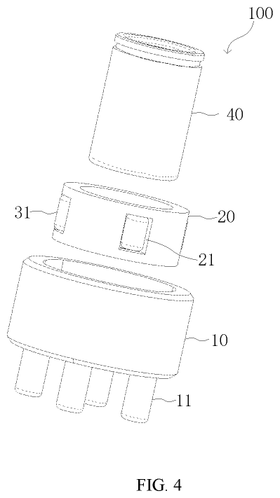

For example, with reference to FIG. 4, the transmission part 20 is provided with a clutch piece mounting position 21 for mounting the clutch piece 31. A plurality of clutch pieces 31 may be disposed. At least one separation accommodation zone 32 corresponding to at least one clutch piece 31 of the plurality of clutch pieces 31 is disposed at a side of the drive force receiving part 10 close to the transmission part 20, and each separation accommodation zone 32 corresponds to one combination piece 33.

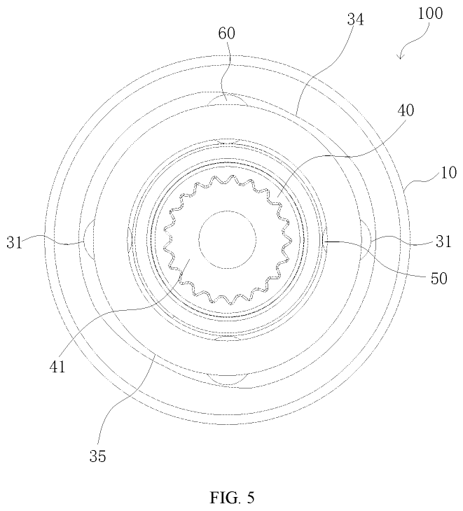

For another example, with reference to FIGS. 4 and 5, the clutch piece mounting position 21 may be an accommodating cavity on the transmission part 20, a first opening (not shown) in communication with the accommodating cavity is disposed at a side of the transmission part 20 close to the drive force receiving part 10, and a second opening (not shown) in communication with the accommodating cavity is disposed at a side of the transmission part 20 close to the drive force outputting part 40. The first opening is larger than the second opening, such that a second region 60 of the clutch piece 31 exposed at the first opening is larger than a first region 50 of the clutch piece 31 exposed at the second opening. When the clutch piece 31 is located in the separation accommodation zone 32, the clutch piece 31 cannot slip out of the first opening to the separation accommodation zone 32.

Further, the first region 50 of the clutch piece 31 is smaller than the second region 60 of the clutch piece 31. For example, when the drive force receiving part 10 receives a drive force, the clutch piece 31 is engaged with the combination piece 33 through the separation accommodation zone 32 (i.e. the first gap), and the combination piece 33 squeezes the second region 60 of the clutch piece 31 to enable the first region 50 of the clutch piece 31 to be in close contact with the drive force outputting part 40. Thus, the drive force receiving part 10 realizes torque transfer by use of the clutch piece 31 and the drive force outputting part 40.

Specifically, with reference to FIG. 3, for example, when the drive force receiving part 10 receives a drive force of a first direction (clockwise) and rotates, the clutch piece 31 enters the second gap through the first gap (i.e. the separation accommodation zone 32). Because the space of the second gap is not enough for the clutch piece 31 to pass through, the clutch piece 31 is in contact with the first combination surface 34. At this time, the clutch piece 31 is sandwiched between the first combination surface 34 and the drive force outputting part 40. The first combination surface 34 is connected with the drive force outputting part 40 by squeezing the clutch piece 31, so as to realize torque transfer, thus achieving the “engaging” effect.

Furthermore, when the drive force receiving part 10 stops rotating, the drive force receiving part 10 rotates a given distance along the second direction (counterclockwise), such that the clutch piece 31 enters the first gap (i.e. the separation accommodation zone 32). At this time, there is a spacing between the clutch piece 31 and the drive force outputting part 40, that is, the drive force outputting part 40 is not in contact with the clutch piece 31, and the clutch piece 31 stops transmitting torque, thereby achieving the “disengaging” effect. At this time, the drive force outputting part 40 may rotate freely relative to the transmission part 20. When the drive force receiving part 10 receives a drive force of a second direction (counterclockwise) and rotates, the clutch piece 31 is engaged with the second combination surface 35 in the same manner as the first combination surface 34 and the clutch piece 31 are engaged, which will not be repeated herein.

Either the first combination surface 34 or the second combination surface 35 can be disposed at an inner wall of the drive force receiving part 10. For example, the first combination surface 34 and the second combination surface 35 may be in opposite positional relationship or in another positional relationship, which is not limited herein. Specifically, the separation accommodation zone 32 is disposed between two adjacent combination pieces 33.

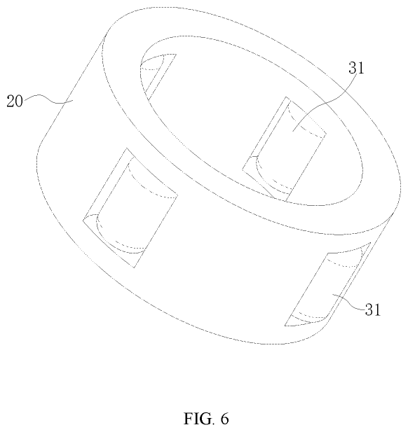

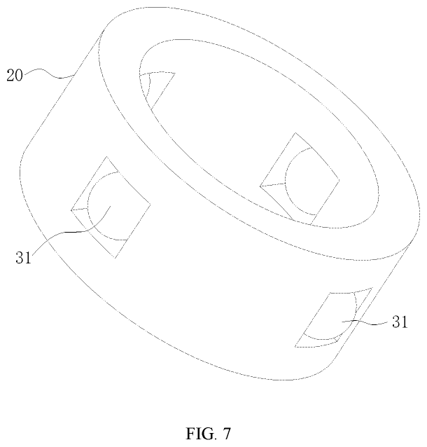

Preferably, with reference to FIGS. 6 and 7, the clutch piece 31 may be of a cylindrical shape or a spherical shape, or other shapes such as cubic shape, which is not limited herein.

Preferably, the clutch 100 further comprises, for example, a damping piece (not shown) which is disposed on the transmission part 20. When the drive force receiving part 10 stops receiving a drive force, the damping piece gives a resistance to the transmission part 20 such that the drive force receiving part 20 and the clutch piece are disengaged, that is, the drive force receiving part 10 is not in contact with the clutch piece 31. For example, the damping piece may be a magnetic piece sandwiched between the transmission part 20 and the drive force outputting part 40.

### Second Embodiment

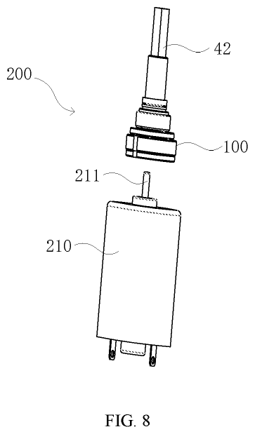

FIG. 8 shows a motor device 200 according to a second embodiment of the present invention. The motor device 200 comprises, for example, the clutch 100 according to the first embodiment and a motor body 210 connected with the clutch 100.

Specifically, the motor body 210 has a drive shaft 211 for outputting a drive force, and the drive shaft 211 is connected with the drive force receiving part 10 of the clutch 100. For example, the drive force receiving rod 11 disposed on the drive force receiving part 10 is a connection shaft hole, and the drive shaft 211 is inserted into the connection shaft hole, such that the motor body 210 can output a forward or backward drive force to the drive force receiving part 10.

The drive force outputting part 40 of the clutch 100 may also be provided with, for example, a drive shaft mounting position 41 (refer to FIG. 1) which is connected with the drive force outputting rod 42 to output a drive force. For example, the drive shaft mounting position 41 may be a connection hole with internal threads, and the drive force outputting rod 42 has a threaded connection end matched with the connection hole. The above purpose can be achieved by inserting the threaded connection end into the connection hole.

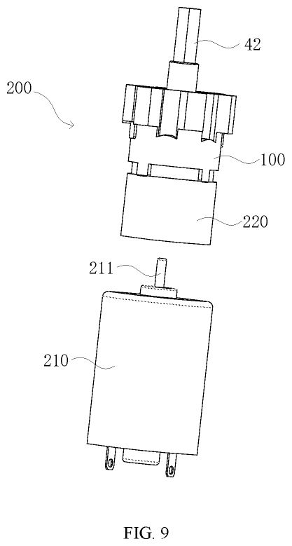

By referring to FIG. 9, the motor device 200 further comprises, for example, a speed reducer 220. The speed reducer 220 is connected between the motor body 210 and the clutch 100. Specifically, the speed reducer 220 may be a planetary speed reducer or another speed reducer, which is not limited herein.

### Third Embodiment

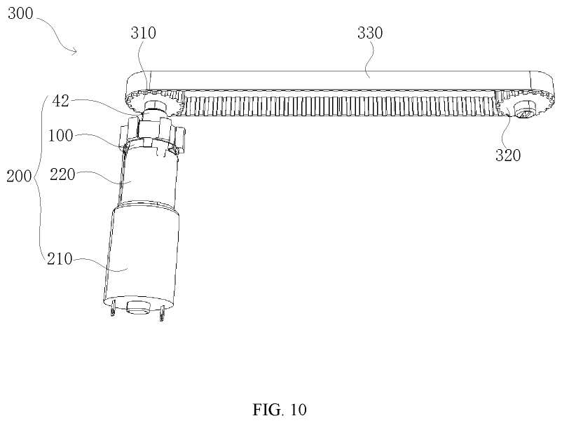

FIG. 10 shows a curtain control device according to a third embodiment of the present invention. The curtain control device 300 comprises, for example, the motor device 200 according to the second embodiment, a first wire reel 310, a second wire reel 320 and a curtain control rope 330.

Specifically, the first wire reel 310 is connected to the drive force outputting part 40 of the motor device 200. Specifically, the first wire reel 310 is connected to the drive force outputting rod 42. A given distance is set between the second wire reel 320 and the first wire reel 310, and the curtain control rope 330 is wound between the first wire reel 310 and the second wire reel 320. For example, the motor device 200 drives the first wire reel 310 to rotate through the drive force outputting part 40, and the first wire reel 310 drives the second wire reel 320 to rotate through the curtain control rope 330.

For example, the first wire reel 310 and the second wire reel 320 may be, for example, gear reels, the curtain control rope 330 may be a geared belt matched with gears of the gear reels, and the geared belt is meshed with the two gear reels respectively. The motor device 200 drives a gear reel serving as the first wire reel 310 to rotate and further drives the other gear reel meshed with the geared belt through the geared belt meshed with the first wire reel 310, which will not be redundantly described herein.

The curtain control device may be used, for example, in the following manner: the first wire reel 310 and the second wire reel 320 are fixed at both ends of a window respectively, the curtain control rope is wound between the first wire reel 310 and the second wire reel 320, and the motor device 200 is connected to the first wire reel 310 or the second wire reel 320; and then a curtain is hung on the curtain control rope 330.

### Fourth Embodiment

The fourth embodiment of the present invention further provides a curtain (not shown). The curtain may be an existing curtain such as a fully-automatic curtain, or a semi-automatic curtain. The curtain may be, for example, an opening-closing type curtain, a roller curtain or a blind curtain. The curtain comprises the curtain control device 300 according to the third embodiment, or the curtain comprises the motor device 200 according to the second embodiment, or the curtain comprises the clutch 100 according to the first embodiment.

Finally, it should be noted that the above embodiments are used only to describe the technical solution of the present invention rather than limit the present invention; although detailed describes are made to the present invention by referring to the above embodiments, those skilled in the art shall understand that the technical solution recorded in the above various embodiments may be modified or part of technical features therein are equivalently substituted; these modifications and substitutions do not cause the essence of the technical solution to depart from the spirit and scope of the technical solution of various embodiments of the present invention.

1. A clutch, wherein it comprises:
a drive force receiving part,
a drive force outputting part;
a transmission part, sleeved between the drive force receiving part and the drive force outputting part, and the drive force receiving part is rotatable relative to the transmission part;
a clutch control part, sandwiched between the drive force receiving part and the drive force outputting part, comprising:
a clutch piece, disposed in the transmission part and in contact with the drive force outputting part;
a separation accommodation zone, located at a side of the drive force receiving part close to the transmission part; and
a combination piece, disposed at a side of the drive force receiving part close to the transmission part and close to the separation accommodation zone;
wherein when the clutch piece is located in the separation accommodation zone, a gap is disposed between the clutch piece and the drive force receiving part; when the drive force receiving part rotates, the clutch piece is sandwiched between the combination piece and the drive force outputting part.

2. The clutch of claim 1, wherein the combination piece comprises a first combination surface and a second combination surface; the separation accommodation zone is sandwiched between the first combination surface and the second combination surface; when the drive force receiving part rotates forward, the clutch piece is sandwiched between the first combination surface and the drive force outputting part; when the drive force receiving part rotates backward, the clutch piece is sandwiched between the second combination surface and the drive force outputting part.

3. The clutch of claim 1, wherein at least two clutch pieces are disposed, and the at least two clutch pieces are disposed at different positions of the transmission part; a corresponding separation accommodation zone and a corresponding combination piece corresponding to each of the clutch pieces are disposed at the side of the drive force receiving part close to the transmission part respectively.

4. The clutch of claim 1, wherein the clutch piece is a cylindrical body or a spherical body sleeved on the transmission part.

5. The clutch of claim 1, wherein the transmission part is sleeved around the drive force outputting part, and the drive force receiving part is sleeved around the transmission part.

6. The clutch of claim 1, wherein the transmission part is sleeved around the drive force receiving part, and the drive force outputting part is sleeved around the transmission part.

7. The clutch of claim 1, wherein it further comprises a drive force receiving rod connected with the drive force receiving part, and a drive force outputting rod connected with the drive force outputting part.

8. The clutch of claim 1, wherein it further comprises a damping piece disposed on the transmission part.

9. A motor device, wherein it comprises the clutch of to claim 1, and a motor body, having a drive shaft connected with the drive force receiving part of the clutch.

10. A curtain control device, wherein it comprises the motor device of claim 9, and a first wire reel connected to the drive force outputting part of the motor device; a second wire reel; and a curtain control rope, wound between the first wire reel and the second wire reel.

11. A curtain, wherein it comprises a curtain body, and the motor device of claim 9.
